(19) United States
(12) Patent Application Publication
(10) Pub. No.: US 2018/0308340 A1
(43) Pub. Date: Oct. 25, 2018

(54) INTERNET OF THINGS PLATFORM WITH SYSTEM-ON-CHIP DEVICE

(71) Applicant: NIKOLA LABS ELECTRONIC R & D CORPORATION INC., Scarborough (CA)

(72) Inventors: Kavaskar THIYAGARAJAH, Scarborough (CA); Mayuran SRIKANTHA, Scarborough (CA)

(21) Appl. No.: 15/955,965

(22) Filed: Apr. 18, 2018

Related U.S. Application Data
(60) Provisional application No. 62/486,679, filed on Apr. 18, 2017.

(51) Int. Cl. G08B 21/24; E03C 1/05; G01F 1/86; H04W 4/38

(52) U.S. Cl. CPC G08B 21/245; E03C 1/057; H04W 4/70; H04W 4/38; G01F 1/86

(57) ABSTRACT

The disclosure relates to a system on Chip (SoC) for an Internet of Things (IoT) device. An example use case is a faucet system with a SoC unit. Automatic faucets include different components such as a solenoid valve, sensor and control electronics, power source, and faucet. Automatic faucets turn on in response to different trigger events. The IoT unit can track activity by the faucet, for example. Another example use case in an electrical outlet system with a SoC unit.

### FIELD

The improvements generally relate to the field of Internet of Things (IoT) devices.

### INTRODUCTION

IoT devices are objects with embedded or integrated computing or electronic components that can transmit data over a network.

### SUMMARY

In accordance with an aspect, there is provided a System on Chip (SoC) unit for an Internet of Things (IoT) device, comprising an electronic component configured to detect or intercept a signal from the IoT device; and a transmitter to send usage data electronically wirelessly to an application or platform, the usage data based on a signal value or property corresponding to the signal.

In some embodiments, the SoC unit comprises a memory to store the usage data.

In some embodiments, the signal comprises a pulse wave, the signal value being a positive value of the pulse wave or a negative value of the pulse wave.

In some embodiments, the SoC unit comprises a controller to generate control signals to actuate the IoT device based on the signal value or property.

In some embodiments, the control signals mimic the signal.

In some embodiments, the electronic component comprises a sensor.

In some embodiments, the sensor is at least one selected from the group of motion, temperature, voltage, current, pressure, humidity, environment, volatile organic compounds (e.g. C02), and proximity sensor.

In some embodiments, the electronic component comprises an ISO electric opto coupler.

In some embodiments, the electronic component comprises a comparator.

In some embodiments, the IoT device comprises a faucet that generates the signal corresponding to an on-state for the faucet or an off-state for the faucet.

In some embodiments, the IoT device comprises an electrical outlet that generates the signal corresponding to a current amount and a voltage amount. The SoC device can determine the real power, reactive power, phase, and other data values.

In some embodiments, the SoC device can record a signal value as a usage data value. An example signal is a pulse wave and there can be a positive signal value and a negative signal value. As an example, the IoT device may be a faucet and there may be one signal value (or a range of values) corresponding to an open valve for the faucet (e.g. an on event) and there may be another signal value (or a range of values) corresponding to a closed valve for the faucet (e.g. an off event). The SoC device can detect an on event and an off event based on the signal value and sends this data to an application or platform. The on event or off event may be usage data for the faucet.

In some embodiments, the SoC device can detect the signal and then stores locally usage data or the signal data. The SoC device can then sends the data to a cloud application. The SoC can also send control signals to the IoT device that mimic the signal pulse to turn the faucet on and off, for example.

Another example IoT device can be an electric circuit and the SoC device can intercept data from the electric circuit to capture usage data relating to the electric circuit. The SoC device can integrate into the electric outlet at a circuit board for a building or near the outlet. The SoC device can detect voltage and current signals to calculate power usage data for storage and transmission. The SoC device can determine the real power, reactive power, phase, and other data values. The SoC device can remotely control the outlet and its power (e.g. throttle) by sending control signals to the circuit board. Another example SoC device can connect to a Thermostat to control a furnace.

The SoC device can provide low cost way of generating business analytics, and generating control data to actuate and control the IoT device based on the usage data.

In another aspect, there is provided a System on Chip (SoC) device integrated with sensors for tracking usage data for an IoT device; a transmitter for electronically wirelessly transmitting the usage data to an application or platform; a memory for storing the usage data; and a controller for generating control signals foe the IoT device based on the usage data. Example sensors or electronics include motion, temperature, voltage, current clamp, motion/proximity sensor, humidity, environment, pressure, temperature, lighting, volatile organic compounds (e.g. C02), passive electronic devices that can detect pulse e.g. ISO electric opto coupler, a comparator that receives two different values and compares them and if one is higher gives a 1 and if lower gives 0 to determine if there is a positive or negative signal, and so on.

In some embodiments, the IoT device comprises a faucet and the usage data corresponds to faucet on events and faucet off events.

In some embodiments, the SoC device is configured to integrate with an electromechanical valve of a faucet for tracking usage data corresponding to faucet on events and off events.

In some embodiments, the SoC device is configured to integrate with a valve and a faucet, the device for tracking faucet on events and off events and transmitting data for the faucet on events and off events.

In some embodiments, the SoC device detects or intercepts a signal from a proximity sensor in the valve of the faucet, and sends the signal electronically wirelessly to an application or platform.

In some embodiments, the SoC device is configured to integrate with an electrical outlet for tracking usage data corresponding to voltage data, current data, and power data.

In another aspect, there is provided an Internet of Things (IoT) platform comprising: a processor configured to generate an interface with visual elements corresponding to usage data for a system of IoT devices; System on Chip (SoC) units for the IoT devices, each SoC unit comprising an electronic component configured to detect or intercept a signal from a corresponding IoT device; and a transmitter to send usage data values electronically wirelessly to the processor, the usage data based on a signal value or property corresponding to the signal; and data storage device for storing the usage data values.

In accordance with an aspect, there is provided an automatic faucet tracking system.

In accordance with another aspect, there is provided System on Chip (SoC) unit for an Internet of Things (IoT) device for detecting usage data and remotely controlling the IoT device.

In accordance with another aspect, there is provided System on Chip (SoC) unit integrated with a valve for a faucet.

In accordance with another aspect, there is provided System on Chip (SoC) unit integrated with a valve and a faucet to create an IoT device.

In accordance with another aspect, embodiments relate to processes for tracking devices with SoC unit.

In accordance with another aspect, embodiments relate to a device having a SoC unit configured to integrate with a valve for a faucet, the device for tracking faucet on events and off events and transmitting data for the faucet on events and off events.

In accordance with another aspect, embodiments relate to a device having a SoC unit integrated with a valve for a faucet, the device for tracking faucet on events and off events and transmitting data for the faucet on events and off events.

In accordance with another aspect, embodiments relate to a device having a SoC unit integrated with a valve and a faucet, the device for tracking faucet on events and off events and transmitting data for the faucet on events and off events.

Many further features and combinations thereof concerning embodiments described herein will appear to those skilled in the art following a reading of the instant disclosure.

### DESCRIPTION OF THE FIGURES

Embodiments will now be described, by way of example only, with reference to the attached figures, wherein in the figures:

FIG. 1A shows an example SoC unit;

FIG. 1B shows an example system with the SoC unit;

FIG. 1C shows an example faucet system with the SoC unit;

FIG. 2 shows an example system with the SoC unit;

FIG. 3 shows an example workflow with the SoC unit;

FIG. 4 shows an example interface for data collected by the SoC unit;

FIG. 5 shows an example schematic for the SoC unit;

FIG. 6 shows an example workflow with the SoC unit;

FIG. 7 shows an example schematic for the SoC unit;

FIG. 8 shows an image of an example prototype SoC unit;

FIG. 9 shows an image of an example prototype SoC unit;

FIG. 10 shows an image of an example prototype SoC unit;

FIG. 11 shows an image of an example faucet system with the SoC unit;

FIG. 12 shows an example schematic for the solution with the SoC unit;

FIG. 13 shows an example process and workflow with the SoC unit;

FIG. 14 shows an example schematic for the faucet platform for the SoC unit; and

FIG. 15 shows an example schematic for the faucet platform for the SoC unit.

FIG. 16 shows an example schematic for an electrical outlet application for the SoC unit.

### DETAILED DESCRIPTION

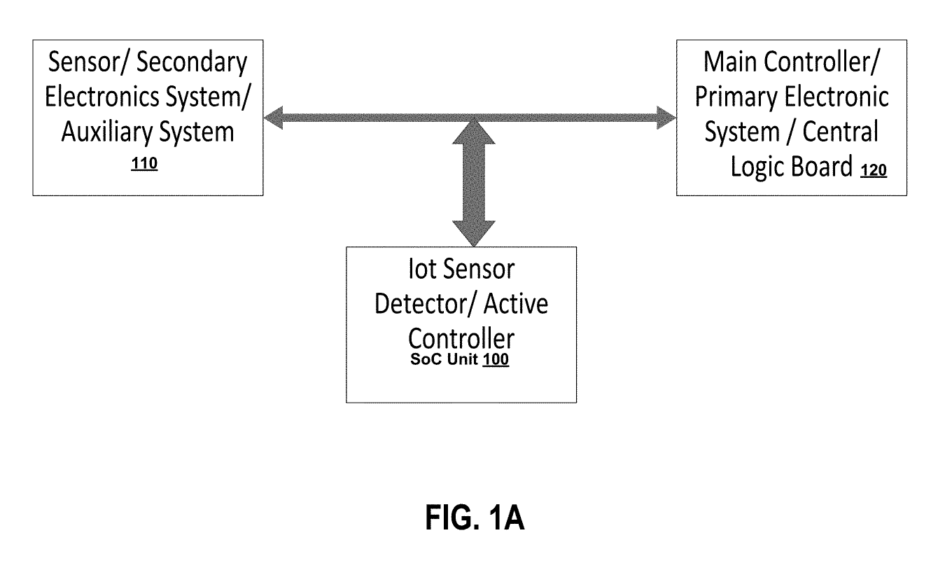

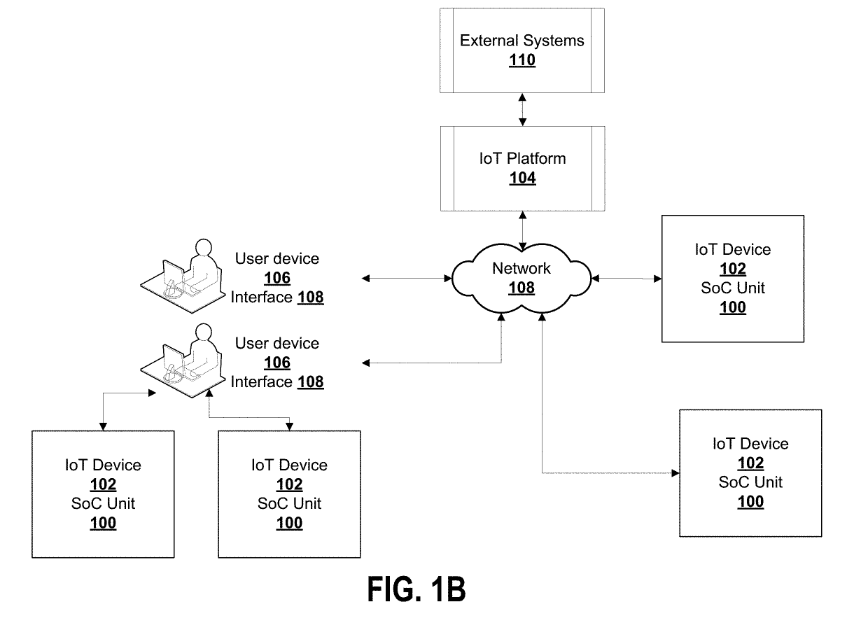

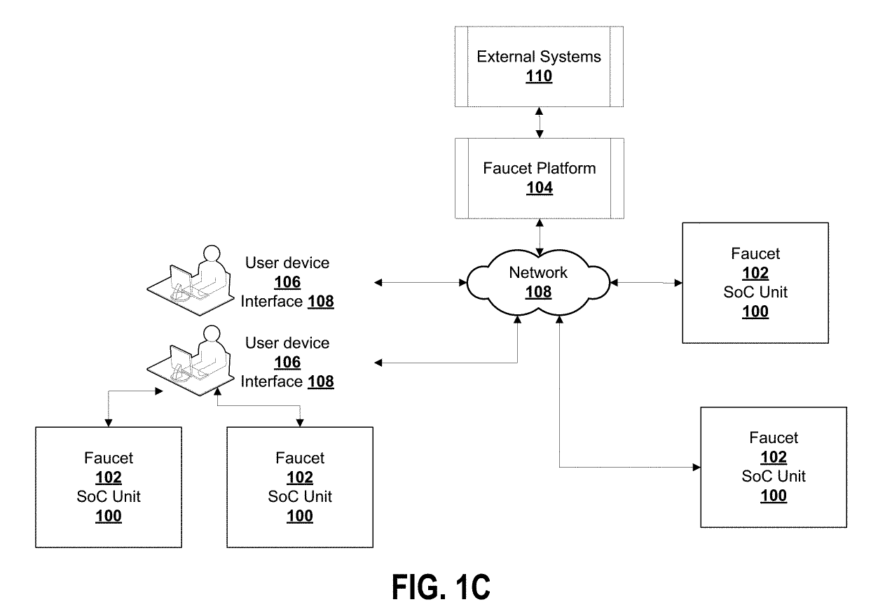

FIG. 1A shows an example System on Chip (SoC) unit 100 for an Internet of Things (IoT) device 102 (FIG. 1B). The SoC unit 102 has an electronic component (e.g. IoT sensor) configured to detect or intercept a signal from an IoT device 102. The SoC unit 100 has a transmitter to send usage data electronically wirelessly to an application or platform. The SoC unit 100 generates the usage data based on a signal value or property corresponding to the signal. The SoC unit 100 has a controller to generate control signals to actuate the IoT device based on the signal value or property. The SoC unit 100 can have a memory to store the usage data.

The SoC unit 100 can integrate with other sensors, electronics system, or auxiliary system 110. The SoC unit can integrate with a main controller, primary electronic system or a central logic board 100.

In some embodiments, the signal from the IoT device 102 can be a pulse wave, the signal value being a positive value of the pulse wave or a negative value of the pulse wave. In some embodiments, the controller generates control signals that mimic the signal. For example, the control signals can be pulse waves. The IoT sensor can be different sensors such as, for example, motion, temperature, voltage, current, and proximity sensors. The IoT sensor can an ISO electric opto coupler. The IoT sensor can a comparator that compares two values and generates usage data as a result of the comparison.

In some example embodiments, SoC unit 100 can integrate with an IoT device 102 such as a faucet that generates the signal corresponding to an on-state for the faucet or an off-state for the faucet. In some embodiments, SoC unit 100 can integrate with an IoT device 102 such as an electrical outlet that generates the signal corresponding to a current amount and a voltage amount. The SoC unit 100 can determine the real power, reactive power, phase, and other data values.

In some embodiments, the SoC unit 100 can record a signal value as a usage data value. An example signal is a pulse wave and there can be a positive signal value and a negative signal value. As an example, the IoT device 102 may be a faucet and there may be one signal value (or a range of values) corresponding to an open valve for the faucet (e.g. an on event) and there may be another signal value (or a range of values) corresponding to a closed valve for the faucet (e.g. an off event). The SoC unit 102 can detect an on event and an off event based on the signal value and send this data to an application or platform. The on event or off event may be usage data for the faucet.

In some embodiments, the SoC unit 100 can detect the signal and then stores locally usage data or the signal data. The SoC unit 100 can then sends the data to a cloud application. The SoC unit 100 can also send control signals to the IoT device 102 that mimic the signal pulse to turn the faucet on and off, for example.

Another example IoT device 102 can be an electric circuit and the SoC unit 100 can intercept data from the electric circuit to capture usage data relating to the electric circuit. The SoC unit 100 can integrate into the electric outlet at a circuit board for a building or near the outlet. The SoC unit 100 can detect voltage and current signals to calculate power usage data for storage and transmission. The SoC unit 100 can remotely control the outlet and its power (e.g. throttle) by sending control signals to the circuit board. Another example SoC unit 100 can connect to a Thermostat to control a furnace.

The SoC unit 100 can provide low cost way of generating business analytics, and generating control data to actuate and control the IoT device based on the usage data.

FIG. 1B shows an example SoC units 100 that can be part of an Internet of Things (IoT) platform 104 having a processor configured to generate an interface with visual elements corresponding to usage data for a system of IoT devices 102. The SoC units 100 couple to the IoT devices 102. Each SoC unit 100 can have an electronic component configured to detect or intercept a signal from a corresponding IoT device 102. The SoC unit 100 can have a transmitter to send usage data values electronically wirelessly to the processor of the platform 104. The usage data can based on a signal value or property corresponding to the signal; and data storage device for storing the usage data values.

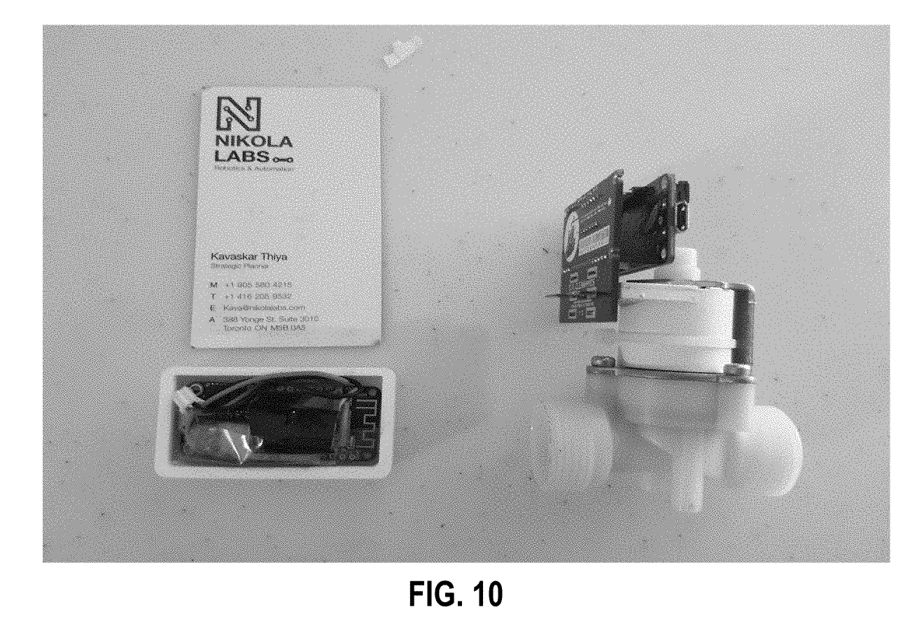

FIG. 10 shows a system with a SoC unit 100 and a faucet 102 connected to a faucet platform 104 via network 108. In some example embodiments, the SoC unit 100 detects or intercepts a signal from a proximity sensor in the valve of the faucet 102, and sends the signal electronically wirelessly to an application at user device 106 or faucet platform 104. The signal data can include usage data for the faucet 102, for example.

The IoT device 102 may be referred to as an automatic valve or a smart valve. The valve may integrate with a faucet. Automatic faucets include different components such as a solenoid valve, sensor and control electronics, power source, and faucet. Automatic faucets can turn on in response to different trigger events.

A solenoid valve enables the physical starting and stopping of water flow by the valve opening and closing. Sensor and control electronics sense the presence of an object in front of the faucet and send control commands to the solenoid valve to initiate the flow of water. When the object is no longer present, the sensor and control electronics send control commands to the solenoid valve to terminate the flow of water, but after a predetermined time have passed, which may be referred to as an off delay time that is generally measured in seconds. The solenoid valve as well as sensor and control electronics require power source. There is a faucet spout for water delivery. Most automatic faucet spouts are designed to house the sensor capsule. The faucet can house fiber optic cables to carry infrared signal from the sensor to the spout. Some spouts house within them the sensor, control electronics, solenoid valve, and even, batteries.

A user device 106 has interface 108 to display data and exchange data and control commands. In some embodiments, faucet 102 and SoC unit 100 may connect to user device 106. The faucet platform 104 aggregates data received from SoC units 100 and generates visual elements to update a dashboard on interface 108 of user device 108. The faucet platform 104 connects to other components in various ways including directly coupled and indirectly coupled via the network. Network 108 (or multiple networks) is capable of carrying data and can involve wired connections, wireless connections, or a combination thereof. Network 108 may involve different network communication technologies, standards and protocols.

Example embodiments relate to a device having a SoC unit 100 configured to integrate with a valve for a faucet, the device for tracking faucet on events and off events and transmitting data for the faucet on events and off events. Other embodiments relate to a device having a SoC unit 100 integrated with a valve for a faucet, the device for tracking faucet on events and off events and transmitting data for the faucet on events and off events. The device can look similar to a standard valve with plastic protruding enclosure built into it seamlessly. Further embodiments relate to a device having a SoC unit 100 integrated with a valve and a faucet, the device for tracking faucet on events and off events and transmitting data for the faucet on events and off events. The SoC unit 100 is configured for signal detection to track the faucet on events and off events. That is, SoC unit 100 detects signals from sensors and valve to track the faucet on events and off events. The SoC unit 100 transmits the data from detected signals to platform 104 for aggregation with data received from other SoC units 100. The faucet platform 104 aggregates the usage data (e.g. tracked on events and off events) received from SoC units 100 and generates visual elements to update a dashboard on interface 108 of user device 108. The SoC unit 100 is operable to calculate water consumption, for example, by tracking flow rates and duration of on event, for example.

While proximity-based operation of faucets may be known, the activity of these faucets (are they on or off, and the duration of being on) are not tracked or measured autonomously. The SoC unit 100 is able to track and report operation autonomously and continuously.

The ability for SoC unit 100 to load content on a screen can involve proximity-based advertising solutions using a proximity sensor. The SoC unit 100 loads content on a screen based on a signal from proximity sensor in the electromechanical valve in the faucet, versus a direct proximity sensor mounted in the screen itself.

The SoC unit 100 is configured for signal detection to track the faucet on events and off events. SoC unit 100 is based on intercepting the signal from the proximity sensor in the electromechanical valve in a faucet, and sending it electronically wirelessly to an application (e.g. platform 104). SoC unit 100 is able to detect or intercept the signal based in some example by integrating with sensor that implement by passive listening on the signal generated between faucet and valve for the faucet on events and off events. In some embodiments, the sensor is an adapter accessory that can be added to the SoC unit 100.

The SoC unit 100 is configured for passive data collection of the valve states. The SoC unit 100 is configured to remotely control the valve states using control signals generated by a controller for turning or actuating an on/off valve.

SoC unit 100 has the ability to send the signal electronically wirelessly indicating that the faucet has been turned on or off. SoC unit 100 has the ability to track individual engagements from faucets. SoC unit 100 has the ability to calculate water usage from signal data collected from individual faucets. SoC unit 100 has the ability to change content on a screen based on the usage of a faucet. SoC unit 100 has the ability to track individual interaction with the faucet (coming with a wearable solution that gets integrated).

The SoC unit 100 is able to send the signal electronically wirelessly by integrating into the proximity sensor integrated into the electromechanical valve in the faucet. The SoC unit 100 is an IoT solution that requires electronics engineering, research and development for the faucet and electromechanical valve. The SoC unit 100 intercepts the proximity sensor signal and sends that signal electronically wirelessly to another application or platform 104.

The SoC unit 100 can have:
the ability to track individual engagements (e.g. on events, off events) from faucets
the ability to calculate water usage from individual faucets
the ability to change content on a screen based on the usage of a faucet
the ability to track individual interaction with the faucet (coming with a wearable solution that can be integrated)
the ability to control the valve using control signals

There could be different IoT solutions for tracking the individual engagement of faucets. For example, each faucet could have a separate proximity sensor installed (not the sensor in the electromechanical valve). This sensor could be developed to track engagement, and ultimately the other key innovations. However, this solution means adding another proximity sensor, which can be redundant.

Example use cases include: (1) Hand Hygiene Compliance; (2) Water Usage Tracking and Water Conservation (ability to see how much water each faucet is using, and when the faucets are being used, which helps with building operations management as well); (3) Advertising and Promotion, Custom Messaging, General Communication (e.g. news, weather); and (4) interactive communication platform.

For Hand Hygiene Compliance (HHC) the SoC unit and platform 104 can collect data for HHC activity; analyze and predict HHC activity using baseline measurements; identify and focus high-risk areas for education and compliance audits; provide interactive and engaging HHC education through live, real-time content.

The SoC unit 100 is an IoT device that can be used to create a smart valve, smart faucet or smart station. The SoC unit 100 is a device that converts a standard electromechanical valve that is equipped with a proximity sensor to a smart valve. The standard valve opens and closes, turning on and off water flow, based on detection of a body nearby. The SoC unit 100 is able to take the signal from the standard valve opening and closing, and send an electronic notification wirelessly to an application that tracks when the faucet was turned on and off. The SoC unit 100 or application can create a time stamp historical record for each on event and off event. For example, the SoC unit 100 or application can a record for each individual on event and off event, or can make a record for an on/off combination. From tracking this information, the SoC unit 100 or application is able to track individual valve activity and calculate information such as the duration that the valve was open and the amount of water that flowed through the valve, both for individual valves and in aggregate.

When the SoC unit 100 is connected to a standard electromechanical valve to convert it to a smart valve, the faucet that the valve is connected to become what can be referred to as a smart faucet, and is itself an IoT device. Accordingly, embodiments described herein can provide a SoC unit 100, a SoC unit 100 integrated with a valve (smart valve) or a SoC unit 100 integrated with a valve and a faucet (smart faucet).

The SoC unit 100 creates the smart valve or smart faucet that can be connected to a display screen with an interface 108, being it a computer monitor, television or mirror television. Now, when the valve or faucet is used, the content on the screen can be changed, through receiving the signal from the SoC unit 100. This allows for educational content, advertising and promotional content, and general content like news and weather to be loaded into an application, and when the SoC unit 100 sends a signal that someone is using the valve/faucet, that specific content can be loaded, creating a smart station.

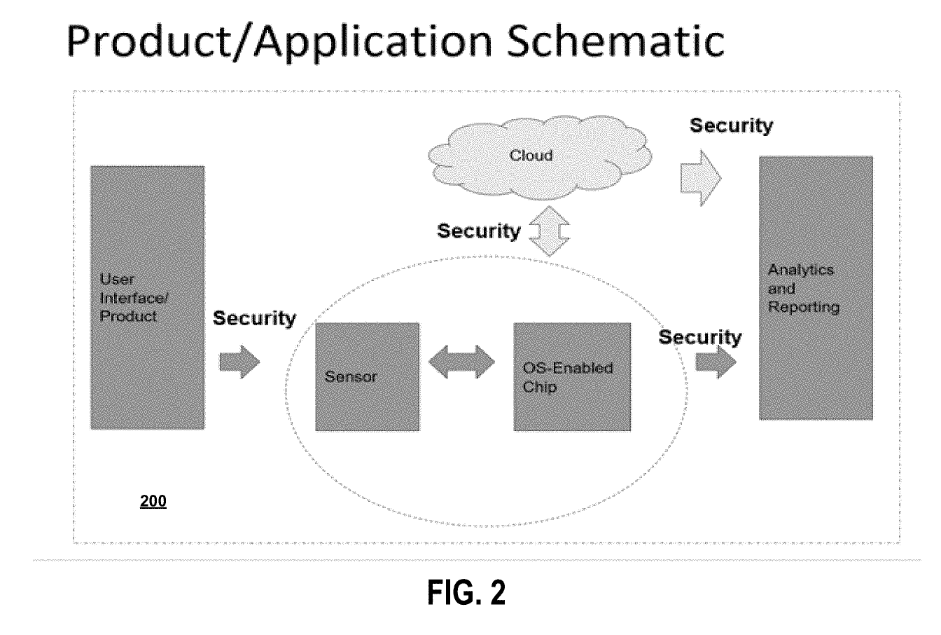

FIG. 2 shows an example system 200 with an Internet of Things (IoT) device that has an Internet connected System-on-chip (SoC) module that can be incorporated into solenoid valves of faucets. The device allows for the real-time detection of valve turn “ON” event and “OFF” event and integrates with sensor. Example applications of the device are for water management, hand washing metrics, healthcare, food processing, hospitality, environmental, building automation, marketing and communications and other IoT use cases. The cloud system includes a user interface and analytics dashboard.

An example solution involving the device is to automate hand sanitation compliance in hospitals, ensuring all staff members effectively sanitize their hands as required. We chose to start with focusing on how to automate how hand washing could be tracked, realizing we could automate other elements of hand sanitation later on, such as using alcohol-based rubs and soap. Currently, hand sanitation compliance is observed in hospitals by observing staff directly washing their hands. This observation leads to bias.

To focus on hand washing, the system automates the tracking of faucet usage. While faucets can be turned on and off via proximity sensor, generally there is no tracking of the faucet usage.

The embodiments provide a platform and process for tracking the faucet usage and incorporate the SoC module with internet protocols such was WIFI, Bluetooth, RFID, Near Field Communication (NFC), and other standards. The device tracking is able to provide valuable business analytics. The device can be used as accessory to a solenoid valve which combined can provide a smart valve solution. Another example solution is to build a valve that comes incorporated with the device and sell as one device.

In some embodiments, the SoC unit will allow remotely turning on the valve as well as matching events with users who are participating with a wearable, cellphone or other ID system.

As all automatic faucet use a solenoid valve for control. By default a smart valve solution will also turn the faucet into an internet connected faucet providing IOT data. Embodiments provide a SMART Faucet.

Embodiments provide a washing station that includes SoC Unit 100 and Faucet 102 and external components 110 like smart Mirror. The components, such as the faucet and screen can be changed as required to make the device into a SMART Station.

IoT is a new technology platform that allows objects, both animate and inanimate, to communicate with each other through the use of remote signals. These signals are transmitted through the air, such as through wireless, Bluetooth communication standards, mesh networks, and so on. Essentially, each object in a network can be considered a node in the network that can communicate with each other, and outside of the network. This ability allows objects in the network to be considered SMART, which means the objects are able to: receive instructions from outside of the network; be controllable (within its functionality); report data to outside of the network.

Embodiments provide an IoT platform with on sensor-chip design, software development and data analytics. This can be a solution for automated hand hygiene compliance in hospitals, for example. The SMART faucet platform 104 is able to track the following: engagement of the faucet; and water usage by the faucet. These capabilities may be of interest due to importance of water conservation, and overall energy, environmental and climate change policy initiatives.

There is insight into the amount of water used by current fixtures, and support the development of water fixture standards as well as provide further insight into building operations. Additionally, the SMART Faucet provides IoT gateway into building to facilitate future mesh network implementation. This gateway allows for future application development, since it provides a platform and portal into a building or a network of buildings. Essentially, the installation of the SMART faucet can be a step in transforming a building into being IoT ready. The SMART faucet is based on hardware and software engineering. The SMART faucet is enabled by a sensor chip system that serves to make the faucet SMART and IoT ready. The SoC unit 100 includes the chip. The chip is supported by the IoT platform 104 with full reporting and analytics capability through the provision of a dashboard on interface 106. The SMART faucet 102 can enable: connectivity; sensor maintenance; data storage; data security and access; and user acceptance.

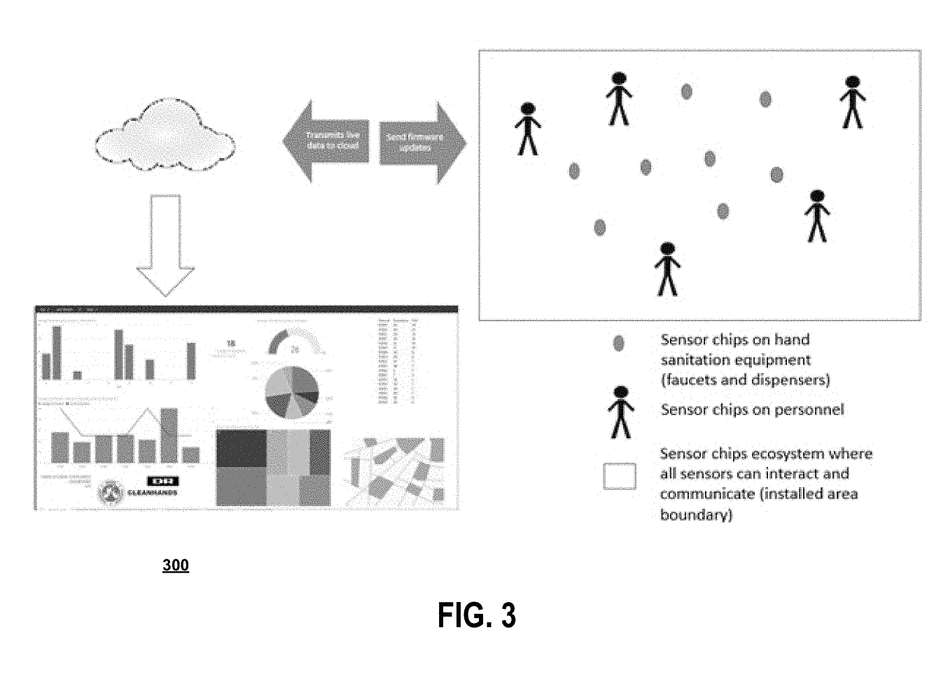

FIG. 3 shows an example workflow 300 for the SoC unit 100 for a hand sanitation system. The SoC unit 100 integrates with hand sanitation equipment. Sensor chips can also be attached to personnel. The system provides an ecosystem where sensors can interact and communication. The data is sent to cloud servers to populate interface dashboard.

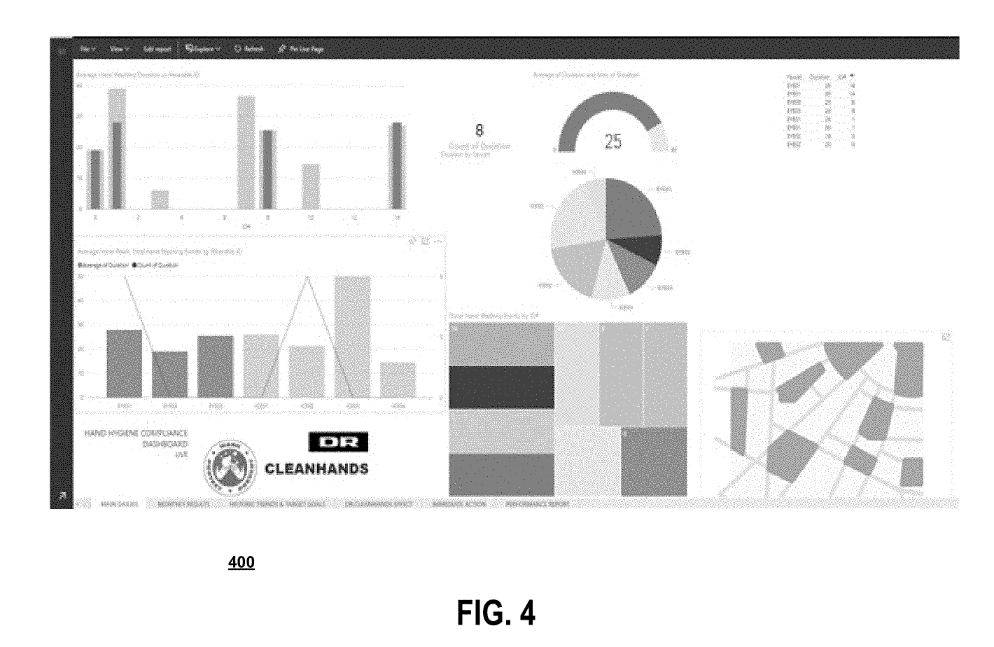

FIG. 4 shows an example interface 400 with visual elements for data collected by the SoC unit 100. The data is collected from SoC units 100. The interface includes different visual elements to indicate data trends.

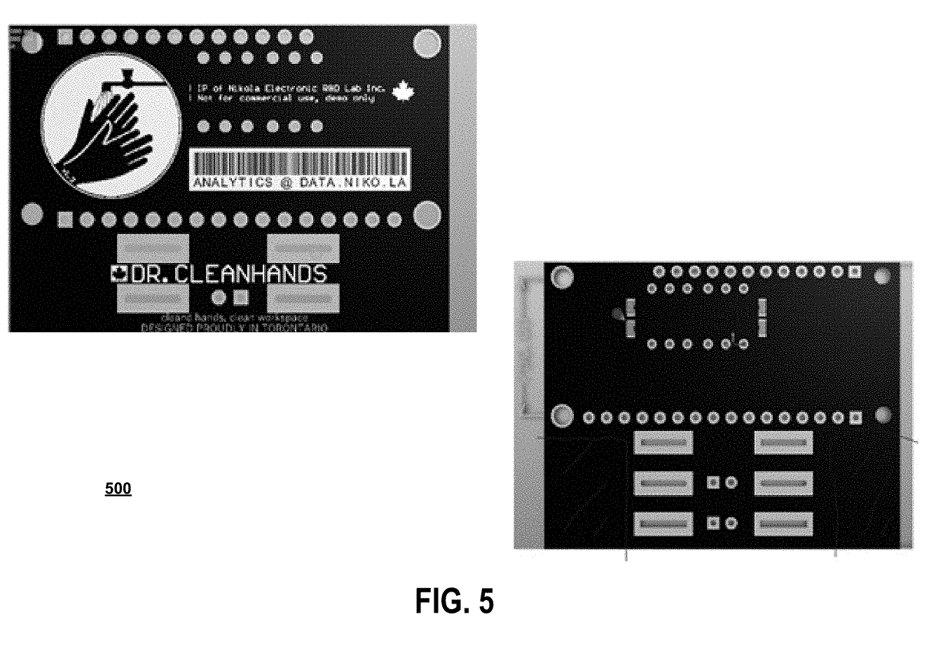

FIG. 5 shows an example representation 500 of the SoC unit 100. The image shows two sides of the chip for the SoC unit 100.

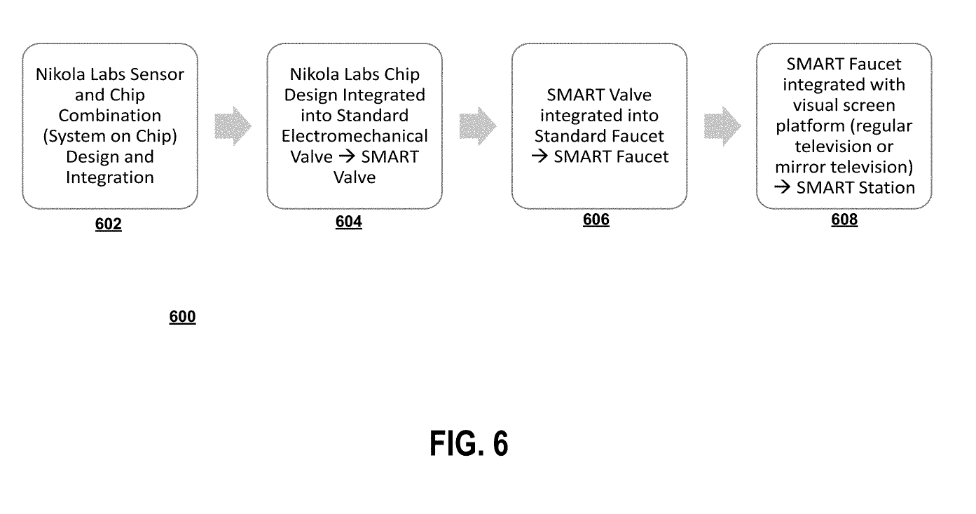

FIG. 6 shows an example workflow 600 with the SoC unit 100. The workflow involves integrating a sensor and the SoC unit 100 at 602, integrating the SoC unit 100 and sensor with the valve at 604, collecting data at 606, and generating visual elements for interface at 608.

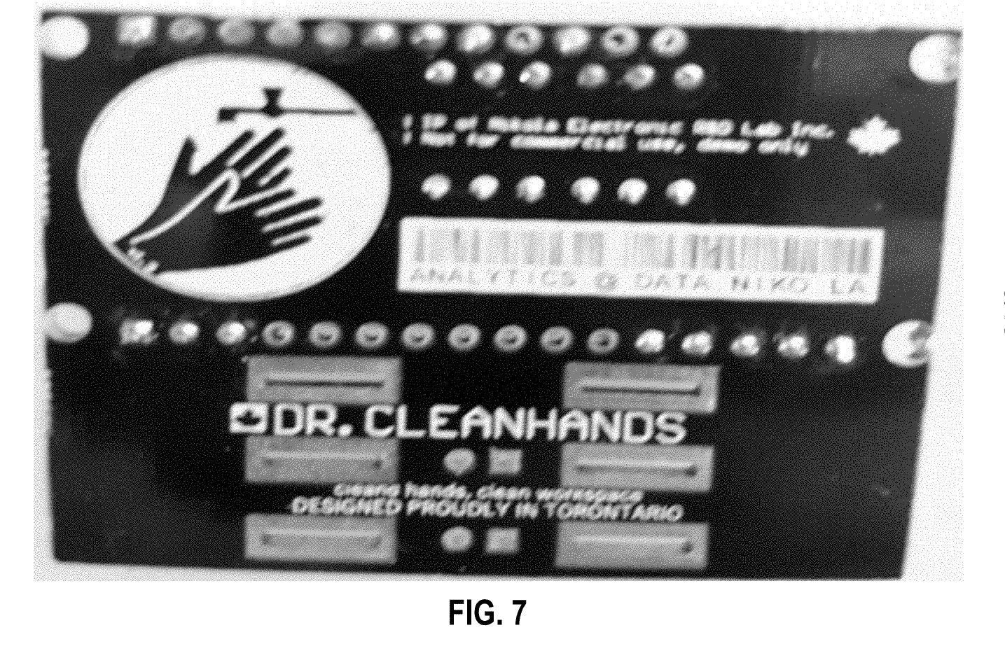

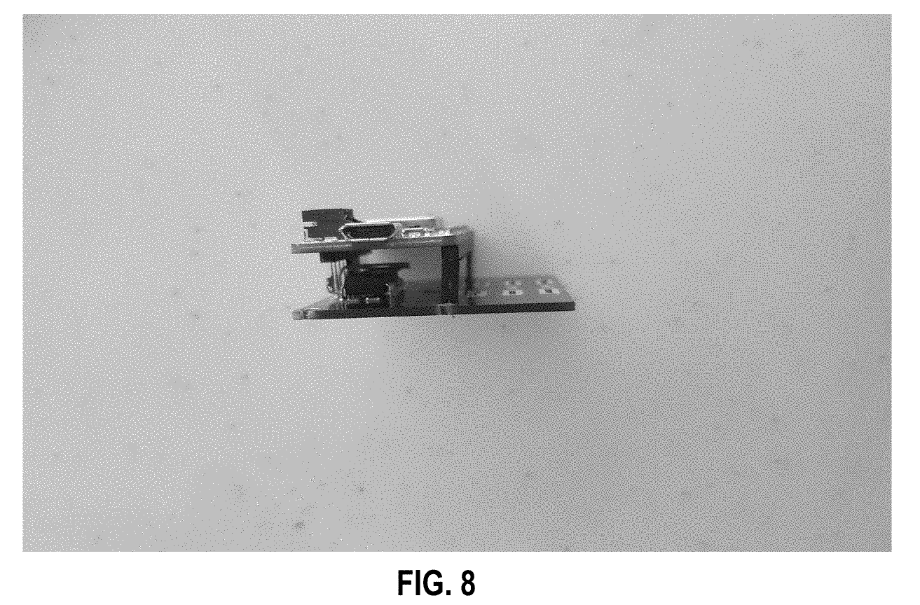

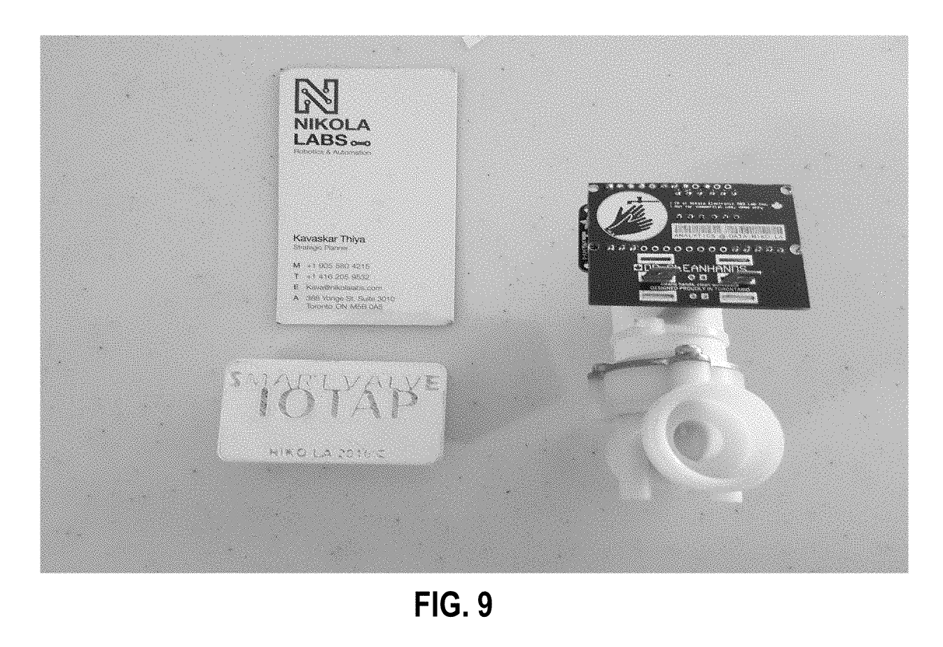

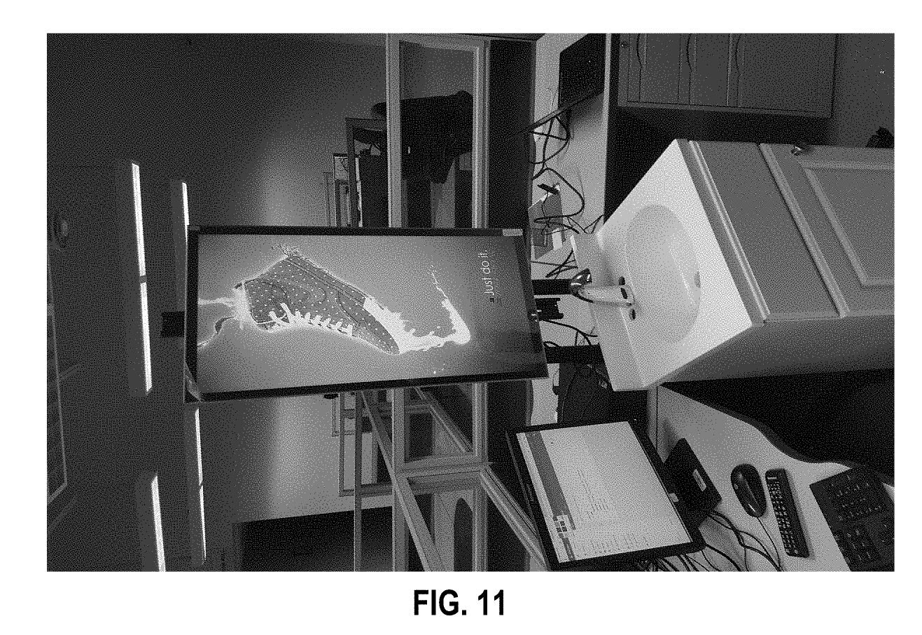

FIG. 7 shows an image of components for the SoC unit 100. FIG. 8 shows an image of an example SoC unit 100. FIG. 9 shows an image of an example SoC unit 100 with valve in a first view. FIG. 10 shows an image of an example SoC unit 100 with valve in another view. FIG. 11 shows an image of an example faucet system with the SoC unit 100 and a mirror display.

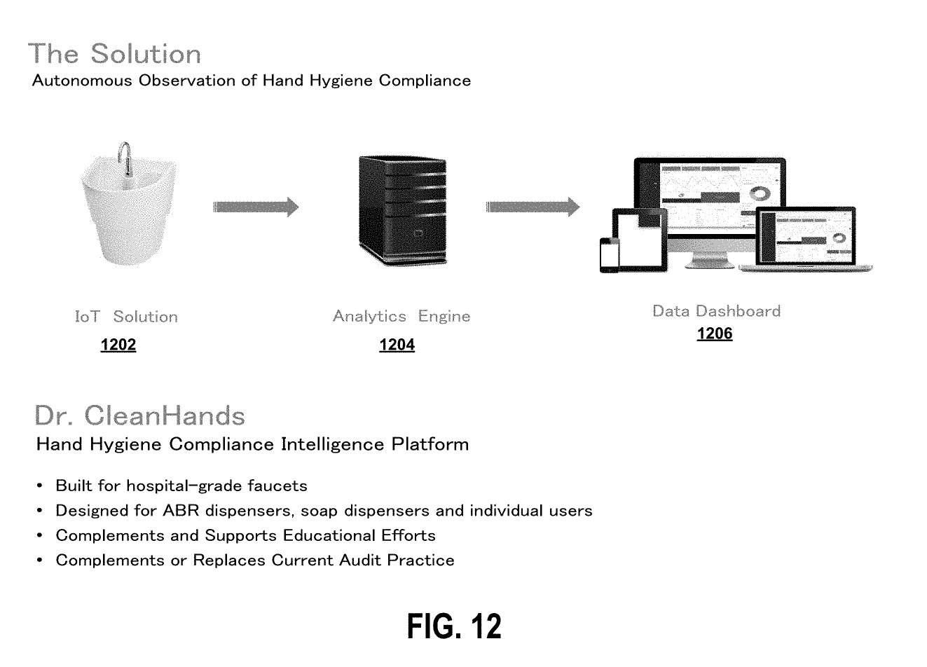

FIG. 12 shows an example schematic for the solution with the SoC unit integrating with components to provide an IoT system 1202, analytics engine 1204 and interface with data dashboard 1206.

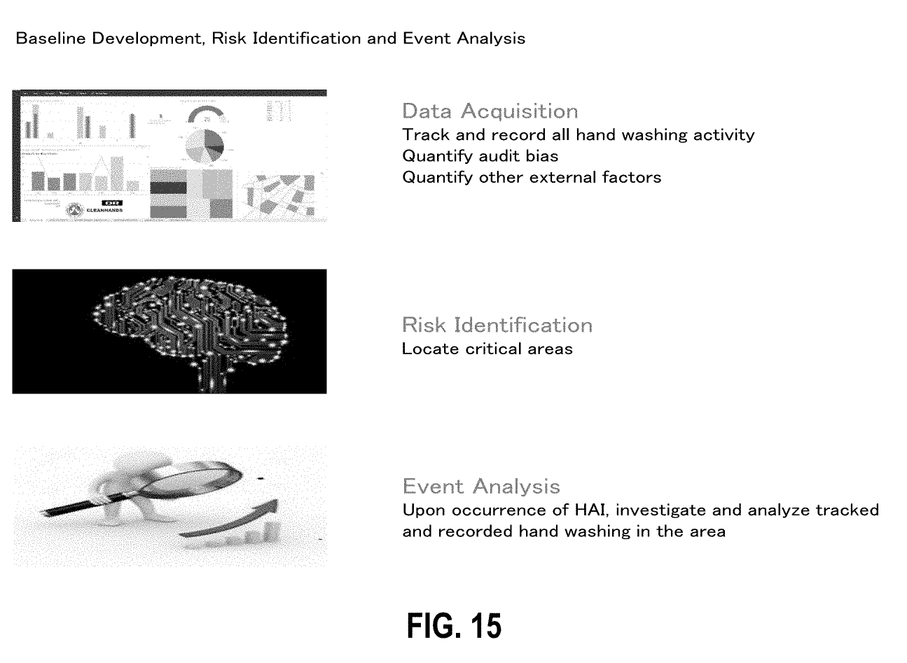

FIG. 15 shows an example schematic for the faucet platform for the SoC unit 100 with data acquisition, risk identification, and event analysis.

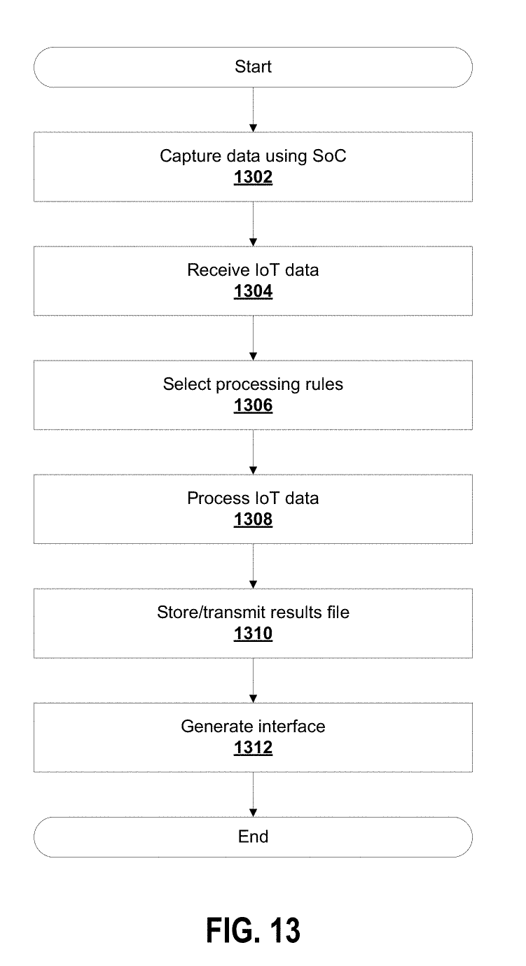

FIG. 13 shows an example process and workflow with the SoC unit. At 1302, the SoC unit 100 captures data, such as ON and OFF events along with faucet identifier. At 1304, the SoC unit 100 transmits data to platform 104. The platform 104 collects data from multiple SoC units 100. At 1306, the platform 104 selects processing rules to generate data reports and visual elements. At 1308, the platform 104 processes the data using the selected machine learning rules. At 1310, the platform 104 transmits data to interface 108 and at 1312 generates visual elements to update interface 108.

Embodiments relate to SoC design and production for designing sensors; designing chips; designing the integration of sensors and chips; designing the operating system; designing the power requirements; designing the enclosure; integrating the system on chip with everyday objects; and ensuring data security.

There is system for designing and producing sensors for electromechanical valve of faucets. There is system that can communicate with the sensor, and relay when the sensor is activated. There is system for the integration of Sensors and Chips. There is SoC unit 100 for communicating with the sensor, and relaying data when the sensor is activated. The SoC unit 100 can include the operating system, power requirements, and so on. The SoC unit 100 can be defined using 3D model and printing.

The SoC unit 100 can be integrated with any electromechanical valve to make it a SMART Valve. The SMART Valve can be integrated into any faucet to make it a SMART Faucet. The SMART Faucet can hook be hooked up to a regular TV, computer monitor or mirror TV to make it a SMART Station.

Embodiments provide for Data Security with encryption. The system wirelessly sends data that is encrypted.

Embodiments provide for a reporting and data presentation platform with a screen interface which shows when the valve/faucet was turned on and off.

Embodiments provide for a database that recorded when each valve/faucet was turned on and off, and calculated how long each faucet was turned on and off, and based on the water flow rate, how much water was used by each faucet.

Embodiments provide for a sample dashboard that shows how the solution can be deployed in a hospital, reporting which faucets were turned on and off, how long each faucet was used, and the amount of water used by the faucet.

Embodiments provide for a screen interface that showed the faucet user when the valve/faucet was turned on and off, featured a counter (both numerically and a bar moving) to track the faucet usage. The content on screen is used to educate a user and assist with the evaluation of a user's hand sanitation performance, or provide other information such as the news, weather, other communications as required. One particular use case is displaying marketing and promotional messaging each time a faucet was engaged.

Embodiments provide for Tracking and reporting when a faucet is turned on or off, for how long it is turned on and off for, and how much water is used by the faucet.

Embodiments provide for displaying content to users based on the faucet being turned on or off through a screen connected to the faucet. This can provide educational or marketing content.

Embodiments provide for display faucet and water usage statistics to others remotely through a database and dashboard. Can create baselines of activity and track improvement or areas or concern. Embodiments provide for developing a Reporting and Data Presentation Platform.

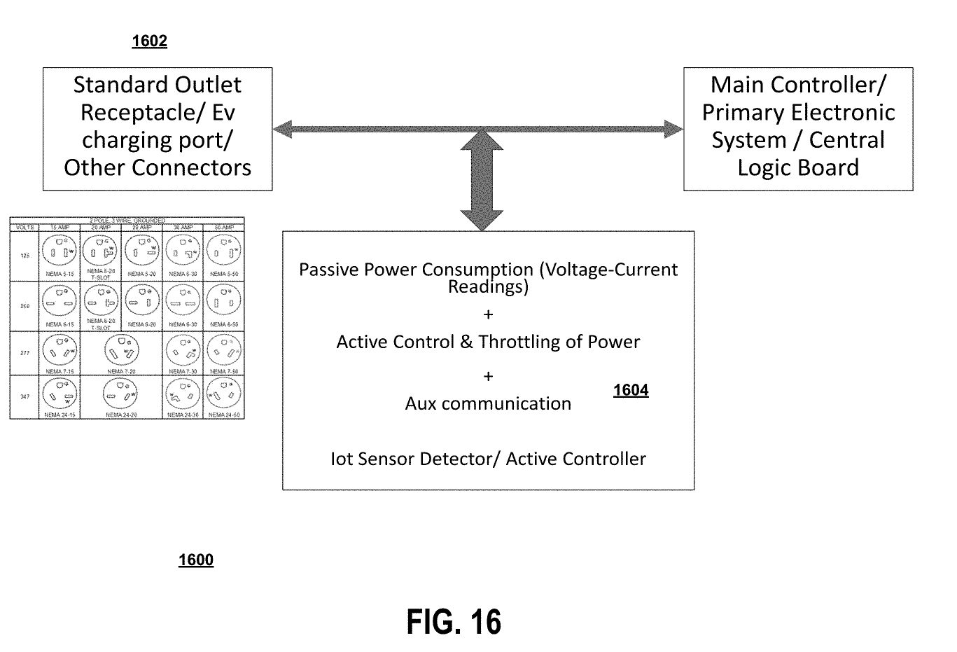

FIG. 16 shows an example schematic for a system 1600 with an electrical outlet 1602 as an example IoT device for the SoC unit 1604.

The system 1600 integrates IoT components with the outlet 1602 to generate a smart outlet. The SoC unit 1604 can have passive power consumption data collection. The SoC unit 1604 can have active control to throttle power generation or power transmission by the outlet 10602 or control board. The SoC unit 1604 can have communication components to transmit usage data for the voltage and current detected. The SoC unit 1604 can have a sensor detector and an active controller. The system 1600 can also include a main controller, primary electronic system and a central logic board. Accordingly, system 1600 can be for building efficiency and automation and SoC unit 1604 can include power monitor sensors.

An example use case can be net-metering, micro electricity transaction and access control. The system 1600 can attach IoT system 1602 to the power panel for a smart circuit breaker use case in some embodiments. The system 1600 can attach IoT system 1602 to the EVSE (electric vehicle charger) for an IoT smart connected charging. These are example use cases. Another use case is a smart grid controller or micro-payments for electricity and access control.

The SoC unit can be part of different systems, such as for example, a Smart Grid Market Settlement Platform (Controller and Software), Energy Storage and Battery (Electronics battery management system/power storage), EV infrastructure (charging, fast charging), Micro Transaction (DLT, BC, smart contract), and Real Time Serverless Database Infrastructure (Software application). These are examples.

The SoC unit integrated with the smart valve and faucet is an example use case. Other examples include integrating the SoC unit with smart mirrors and advertising, and displaying content on the mirrors. The SoC unit enables passive data collection but can also include a controller so that components of the IoT device (e.g. the valve) can be controlled by the SoC unit.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Various example embodiments are described herein. Although each embodiment represents a single combination of inventive elements, all possible combinations of the disclosed elements include the inventive subject matter. Thus if one embodiment comprises elements A, B, and C, and a second embodiment comprises elements B and D, then the inventive subject matter is also considered to include other remaining combinations of A, B, C, or D, even if not explicitly disclosed.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

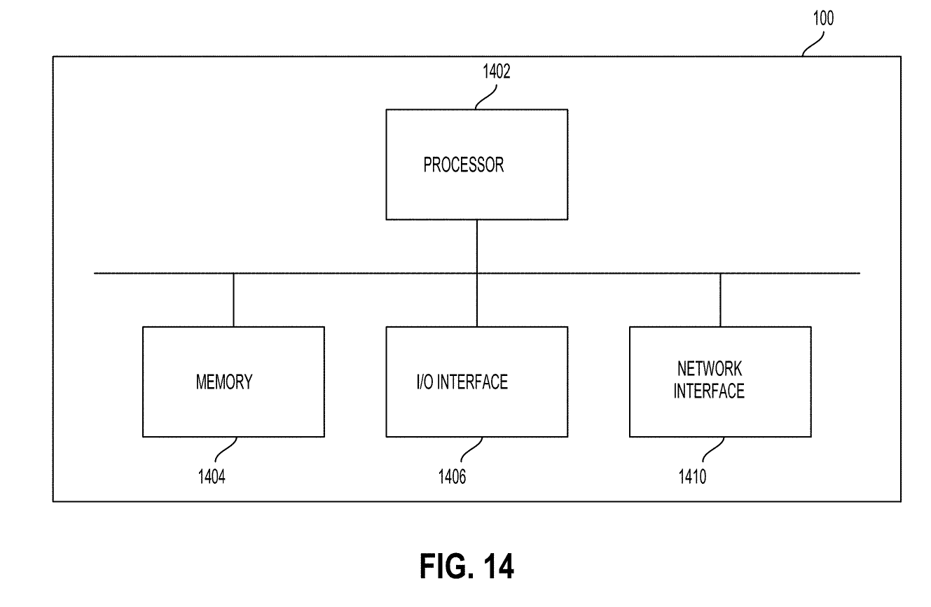

FIG. 14 shows an example schematic for the faucet platform for the SoC unit 100 with a computing device that includes at least one processor 1402, memory 1404, at least one I/O interface 1406, and at least one network interface 1408.

Each processor 1402 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1404 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1406 enables computing device to interconnect with one or more input devices, such as a keyboard, mouse, camera, touch screen and a microphone, or with one or more output devices such as a display screen and a speaker.

Each network interface 1408 enables computing device to communicate with other components, to exchange data with other components, to access and connect to network resources, to serve applications, and perform other computing applications by connecting to a network (or multiple networks) capable of carrying data.

Computing device is operable to register and authenticate users (using a login, unique identifier, and password for example) prior to providing access to applications, a local network, network resources, other networks and network security devices. Computing devices may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. System on Chip (SoC) unit for an Internet of Things (IoT) device, comprising an electronic component configured to detect or intercept a signal from the IoT device; and a transmitter to send usage data electronically wirelessly to an application or platform, the usage data based on a signal value or property corresponding to the signal.

2. The SoC unit of claim 1 further comprising memory to store the usage data.

3. The SoC unit of claim 1 wherein the signal comprises a pulse wave, the signal value being a positive value of the pulse wave or a negative value of the pulse wave.

4. The SoC unit of claim 1 further comprising a controller to generate control signals to actuate the IoT device based on the signal value or property.

5. The SoC unit of claim 1, wherein the control signals mimic the signal.

6. The SoC unit of claim 1, wherein the electronic component comprises a sensor.

7. The SoC unit of claim 1 wherein the sensor is at least one selected from the group of motion, temperature, voltage, current, pressure, humidity, environment, volatile organic compounds, and proximity sensor.

8. The SoC unit of claim 1, wherein the electronic component comprises an ISO electric opto coupler.

9. The SoC unit of claim 1, wherein the electronic component comprises a comparator.

10. The SoC unit of claim 1, wherein the IoT device comprises a faucet that generates the signal corresponding to an on-state for the faucet or an off-state for the faucet.

11. The SoC unit of claim 1, wherein the IoT device comprises an electrical outlet that generates the signal corresponding to a current amount and a voltage amount.

12. A System on Chip (SoC) device integrated with sensors for tracking usage data for an IoT device; a transmitter for electronically wirelessly transmitting the usage data to an application or platform; a memory for storing the usage data; and a controller for generating control signals foe the IoT device based on the usage data.

13. The SoC device of claim 12, wherein the IoT device comprises a faucet and the usage data corresponds to faucet on events and faucet off events.

14. The SoC device of claim 12 configured to integrate with an electromechanical valve of a faucet for tracking usage data corresponding to faucet on events and off events.

15. The SoC device of claim 12 configured to integrate with a valve and a faucet, the device for tracking faucet on events and off events and transmitting data for the faucet on events and off events.

16. The SoC device of claim 15 wherein the SoC unit detects or intercepts a signal from a proximity sensor in the valve of the faucet, and sends the signal electronically wirelessly to an application or platform.

17. The SoC device of claim 12 configured to integrate with an electrical outlet for tracking usage data corresponding to voltage data, current data, and power data.

18. The SoC unit of claim 12 wherein usage data is generated based on signals from the IoT device.

19. The SoC unit of claim 12 wherein signal comprises a pulse wave, the signal value being a positive value of the pulse wave or a negative value of the pulse wave.

20. An Internet of Things (IoT) platform comprising:
a processor configured to generate an interface with visual elements corresponding to usage data for a system of IoT devices;
System on Chip (SoC) units for the IoT devices, each SoC unit comprising an electronic component configured to detect or intercept a signal from a corresponding IoT device;
and a transmitter to send usage data values electronically wirelessly to the processor, the usage data based on a signal value or property corresponding to the signal; and
data storage device for storing the usage data values.
